(19) United States
(12) Patent Application Publication
(10) Pub. No.: US 2026/0198399 A1
(43) Pub. Date: Jul. 16, 2026

(54) METHOD OF CONTROLLING THE MOVEMENT OF A BALE MOVER IN A WORKING AREA

(71) Applicant: Vermeer Manufacturing Company, Pella, IA (US)

(72) Inventors: Kent L. Thompson, Otley, IA (US); Curt T. Graham, Lynnville, IA (US); Nathan D. Dockter, Pella, IA (US); Grant Hoppes, Pella, IA (US); Dean Woodwell, Knoxville, IA (US); Gary J. Burns, Knoxville, IA (US); Mason Carl Prieksat, Pella, IA (US); Rhett Schildroth, North Liberty, IA (US); Lyle Zumbach, Cedar Rapids, IA (US)

(21) Appl. No.: 19/134,568

(22) PCT Filed: Dec. 1, 2023
(86) PCT No.: PCT/US23/82178

§ 371 Date: May 30, 2025

Related U.S. Application Data
(60) Provisional application No. 63/429,904, filed on Dec. 2, 2022.

(51) Int. Cl. A01B 69/04; A01D 87/12; A01D 90/16

(52) U.S. Cl. CPC A01B 69/008; A01D 87/122; A01D 90/16

(57) ABSTRACT

The present invention relates to a method of controlling a bale mover (100) for loading and moving bales in a field in which the bales have been previously baled. The bale movers may include a four-bar linkage for raising and lowering a bed frame between transport and bale load positions. The method comprises the steps of defining a working area (2202), establishing a field of view for a sensor, selecting a bale angle (2214), and creating a scour pattern (2204) that covers the working area. Based on this pattern the bale mover is controlled about the working area to load bales onto the bale mover.

### CROSS-REFERENCE TO RELATED APPLICATIONS

This application claims priority to U.S. Provisional Patent Application Ser. No. 63/429,904, filed on Dec. 2, 2022, the disclosure of which is hereby incorporated by reference in its entirety.

### FIELD OF THE DISCLOSURE

The field of the disclosure relates to bale movers for gathering and moving bales of forage or crop material.

### BACKGROUND

Moving bales of forage or crop material is conventionally done with a tractor with a loader that is controlled by an operator. Bale movers (towed and self-propelled) that move through the field to load and move bales to an unloading site have been developed. For bale movers to be accepted by customers, such bale movers should reliably pick-up bales in the field, be able to pick-up a plurality of bales and safely transport bales to an unload position.

A need exists for bale movers that are able to reliably move bales from a surface of a space onto the mover, that are able to accommodate a variety of bale sizes (e.g., widths, diameters), and/or that improve sensor and controller reliability.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the present disclosure is directed to a bale mover. The bale mover includes a main frame and a bed frame supported by the main frame. First and second bale carrying conveyors are carried by the bed frame. A rear link is pivotally connected to the main frame and is pivotally connected to the bed frame. A front link is pivotally connected to the main frame and is pivotally connected to the bed frame. The rear and front links enable the bed frame to move relative to the main frame.

Another aspect of the present disclosure is directed to a bale mover. The bale mover includes a main frame and a bed frame supported by the main frame. First and second bale carrying conveyors are carried by the bed frame. A link is pivotally connected to the main frame and is pivotally connected to the bed frame. An actuator is pivotally connected to the main frame and is pivotally connected to the bed frame.

Yet another aspect of the present disclosure is directed to a bale mover that includes a bale carrying system and a bale loading system. The bale carrying system includes a first bale carrying conveyor and a second bale carrying conveyor. The bale loading system includes a first bale loading conveyor and a second bale loading conveyor. The first and second bale loading conveyors are moveable relative to each other.

A further aspect of the present disclosure is directed to a method of controlling the movement of a bale mover. A working area is defined. A field of view for a sensor is established. A bale angle is selected. A scour pattern is created that covers the working area based on the field of view and the selected bale angle.

Yet a further aspect of the present disclosure is directed to a bale mover. The bale mover includes a bale carrying system and a power unit. A controller is disposed in the power unit. The bale mover includes a controller mount plate. Isolators connect the controller to the controller mount plate and isolate the controller from the vibrations of the bale mover.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a perspective view of a self-propelled bale mover;

FIG. 2 is another perspective view of the self-propelled bale mover;

FIG. 3 is a side view of the self-propelled bale mover;

FIG. 4 is another side view of the self-propelled bale mover;

FIG. 5 is a top view of the self-propelled bale mover;

FIG. 6 is a rear view of the self-propelled bale mover;

FIG. 7 is another perspective view of the self-propelled bale mover;

FIG. 8 is another perspective view of the self-propelled bale mover;

FIG. 9 is a detailed perspective view of the self-propelled bale mover in a transport position;

FIG. 10 is a detailed perspective view of the self-propelled bale mover in a bale load position;

FIG. 11 is another detailed perspective view of the self-propelled bale mover in the transport position;

FIG. 12 is another detailed perspective view of the self-propelled bale mover in the bale load position;

FIG. 13 is a side view of the self-propelled bale mover approaching a bale in the transport position;

FIG. 14 is a side view of the self-propelled bale mover in the bale load position;

FIG. 15 is a side view of the self-propelled bale mover loading a bale in the bale load position;

FIG. 16 is a side view of the self-propelled bale mover in the transport position with a bale loaded on the bale loading system of the bale mover;

FIG. 17 is a cross-section front view of the self-propelled bale mover showing adjustable first and second bale loading arms;

FIG. 18a is a detailed front view of the self-propelled bale mover showing the second bale loading arm and a second clamp;

FIG. 18b is a side view of a front cross-structure and the second clamp;

FIG. 19 is a perspective view of an embodiment of a towed bale mover;

FIG. 20 is another perspective view of the towed bale mover;

FIG. 21 is a top view of the towed bale mover;

FIG. 22 is a schematic of a bale mover in the transport position (self-propelled, towed or wheeled) ;

FIG. 23 is a schematic of the bale mover in an intermediate position;

FIG. 24 is a schematic of the bale mover in the bale load position;

FIG. 25 is a schematic side view of another embodiment of the bale mover in a transport position wherein an actuator has been substituted for the front link;

FIG. 26 is schematic side view of the bale mover of FIG. 25 in a rear unload position;

FIG. 27 is schematic side view of another embodiment of the bale mover in a transport position wherein wheels have been substituted for the ground tracks;

FIG. 28 is schematic side view of the bale mover of FIG. 27 in an intermediate position;

FIG. 29 is schematic side view of the bale mover of FIG. 27 in a bale load position;

FIG. 30 is a top view of a field that includes a plurality of bales overlayed by a scour pattern with the bale mover in a starting position;

FIG. 31 is a top view of the field showing the travel path of the bale mover while gathering a first load of bales;

FIG. 32 is a top view of the field showing the travel path of the bale mover while gathering a second load of bales;

FIG. 33 is a top view of the field showing the second load of bales being unloaded in a stacking location;

FIG. 34 is a detailed top view of the field showing the second load of bales being unloaded in the first row in the stacking location;

FIG. 35 is a detailed top view of the field showing a third load of bales being unloaded in a second row from the front of the bale mover while the bale mover is reversed;

FIG. 36 is a detailed top view of the field showing a third load of bales being unloaded in a second row from the rear of the bale mover while the bale mover is propelled forward;

FIG. 37 is a detailed top view of the field showing a third load of bales being unloaded in a second row from the front of the bale mover while the bale mover is reversed in a direction of travel opposite the direction of travel of FIG. 35;

FIG. 38 is a block diagram of a control system of the bale mover;

FIG. 39 is a block diagram of components of the control system that control movement of the bale mover;

FIG. 40 is a side view of the bale mover showing a cooling fan and radiator;

FIG. 41 is a side view of a controller of the bale mover adjacent a duct for air flow;

FIG. 42 is a front view of the self-propelled bale mover;

FIG. 43 is a front view of a lidar sensor connected to a mounting bracket of the bale mover;

FIG. 44 is a front view of a sensor package of the bale mover;

FIG. 45 is a top view of the sensor package;

FIG. 46 is a front view of a geo-spatial sensor hub of the bale mover; and

FIG. 47 is a side view of the geo-spatial sensor hub.

Corresponding reference characters indicate corresponding parts throughout the drawings.

### DETAILED DESCRIPTION

Provisions of the present disclosure relate to bale movers for loading, moving, and unloading bales (e.g., round bales) in a space in which the bales have been previously baled. The bale mover may be autonomous. The bale movers may include a four-bar linkage for raising and lowering a bed frame between transport, bale load, and bale unload positions. The bale mover may also include various isolators which improve reliability of one or more controllers and sensors of the bale mover. Provisions of the present disclosure also relate to methods for navigating the bale mover through a field to gather and unload bales.

### Bale Mover

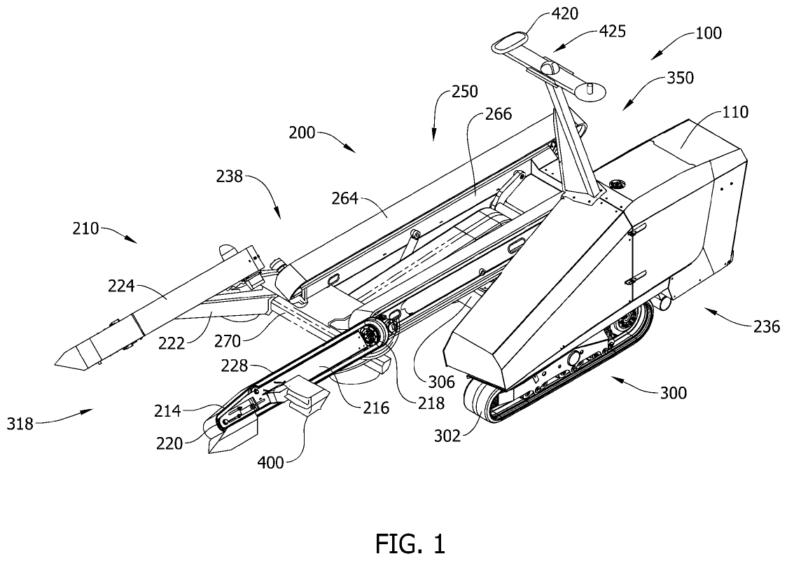

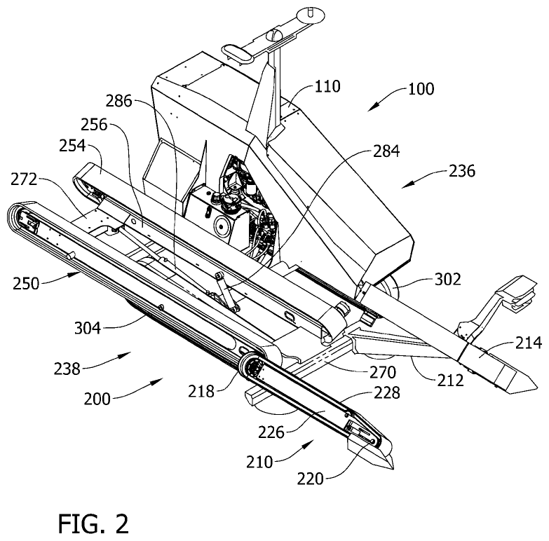

An embodiment of a bale mover 100 is shown in FIG. 1. The bale mover 100 includes a bale support bed 200 mounted to a machine chassis 300. The machine chassis 300 includes a first ground track 302, a second ground track 304 (FIG. 2), and a main frame 306. The bale mover 100 has a front 318 at which bales are loaded and a rear 350 opposite the front 318.

The illustrated bale mover 100 is self-propelled. A power unit 110 is mounted to and supported by the machine chassis 300. The power unit 110 generates power to drive the various tracks and conveyors of the mover 100. The power unit 110 may include a diesel or gasoline internal combustion engine and a fuel tank. The power unit 110 may power hydraulic pumps that power the driven components of the bale mover 100. For example, the pump may power hydraulic motors that drive the first and second ground tracks 302, 304 of the machine chassis 300. Hydraulic pumps may also power the moving components of the bale support bed 200 and power components for raising or lowering the bale support bed 200 as further discussed below. In some embodiments, the power unit 110 may be configured to provide battery power (e.g., include batteries and electric motors that drive the various components). The present disclosure should not be limited to a particular power unit 110 or arrangement of the components of the power unit 110 and any power unit 110 that allows the bale mover 100 to function as described herein may be used unless stated otherwise.

A bale loading system 210 and a bale carrying system 250 form the bale support bed 200 of the mover 100. It should be understood that the function of the bale loading system 210 and the bale carrying system 250 are not limited to or defined by the names identifying reference numbers 210 and 250. Thus, the bale loading system 210 may load bales, carry bales, or load bales and carry bales. The bale carrying system 250 may carry bales, load bales, or carry bales and load bales. The bale loading system 210 includes a first bale loading conveyor 214 on a first side 236 of the mover 100 and a second bale loading conveyor 224 on the second side 238. The first bale loading conveyor 214 includes a first bale loading conveyor frame 216 which is mounted to a first bale loading arm 212 (FIG. 2). The second bale loading conveyor 224 includes a second bale loading conveyor frame 226 (FIG. 2) which is mounted to a second bale loading arm 222 (FIG. 1). The first and second bale loading conveyor frames 216, 226 each support a driven roller 218 and an idler roller 220. A belt 228 rotates about the idler roller 220 and driven roller 218. Although not shown, it should be understood that the belt 228 may rotate about one or more additional rollers. The one or more additional rollers may be positioned at a location between the idler roller 220 and the driven roller 218.

The first and second bale loading conveyors 214, 224 may include one or more wear strips (not shown) may be positioned in direct or indirect contact with the belt 228. The first and second bale loading conveyors 214, 224 may include one or more tensioning components (not shown) may be positioned in direct or indirect contact with the belt 228. The one or more tensioning components (not shown) may be connected, either directly or indirectly, to the idler roller 220, the driven roller 218, or the idler roller 220 and the driven roller 218.

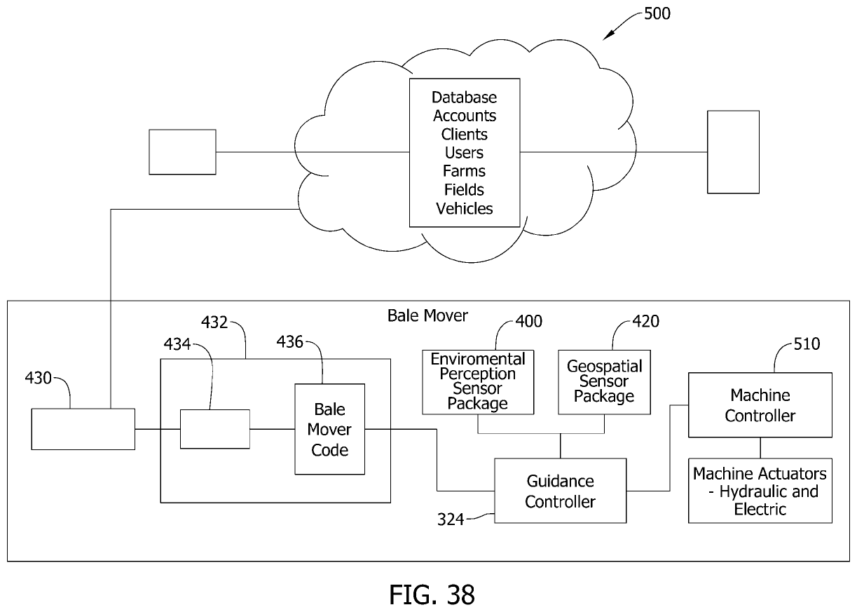

A control system 500 (FIG. 38) may include a machine controller 510 that is communicatively connected to various machine actuators which, in some embodiments, includes hydraulic actuators that drive the driven rollers 218. The machine controller 510 receives data from a variety of sensors (not shown) and regulates the amount of power supplied to the driven rollers 218 by the power unit 110. In some embodiments, the machine controller 510 regulates the speed of rotation of the driven rollers 218 based on the speed of the ground drive tracks 302, 304.

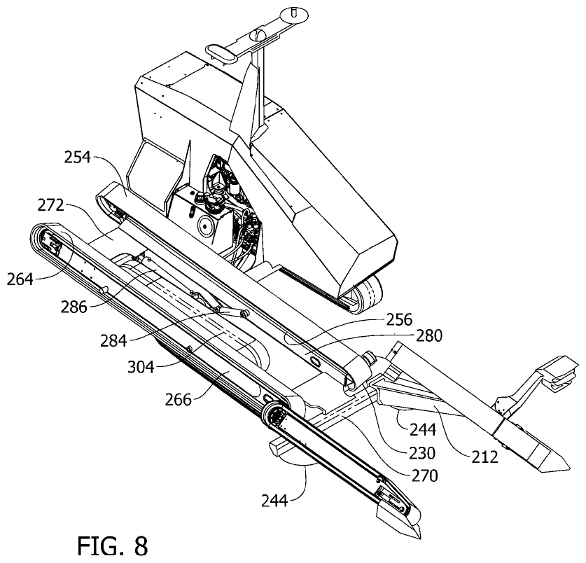

The bale carrying system 250 includes a first bale carrying conveyor 254 (FIG. 2), a second bale carrying conveyor 264 (FIG. 1), and a bed frame 280 (FIG. 8). The first bale carrying conveyor 254 includes a first bale carrying conveyor frame 256 (FIG. 2). The second bale carrying conveyor 264 includes a second bale carrying conveyor frame 266 (FIG. 1). The first bale carrying conveyor frame 256 and second bale carrying conveyor frame 266 are connected by a front cross-structure 270 and a rear cross-structure 272 (FIG. 2). The bale loading arms 212, 222 of the bale loading system 210 are mounted to the front cross-structure 270 and extend from the bed frame 280.

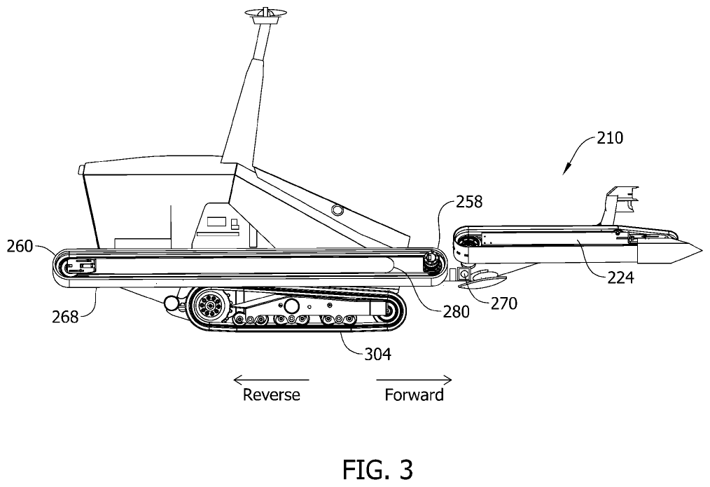

The first bale carrying conveyor frame 256 and the second bale carrying conveyor frame 266 each support a driven roller 258 (FIG. 3) and an idler roller 260. A control system 500 (FIG. 38) regulates the amount of power supplied to the driven rollers 258 by the power unit 110. A belt 268 rotates about the idler roller 260 and the driven roller 258 of each conveyor 254, 264. Referring now to FIG. 8, the first bale carrying frame 256 and the second bale carrying frame 266 are connected to a front cross-structure 270 and a rear cross-structure 272 to form a bed frame 280 (which may be a “rigid” bed frame). The bed frame 280 carries the first and second bale carrying conveyors 254, 264.

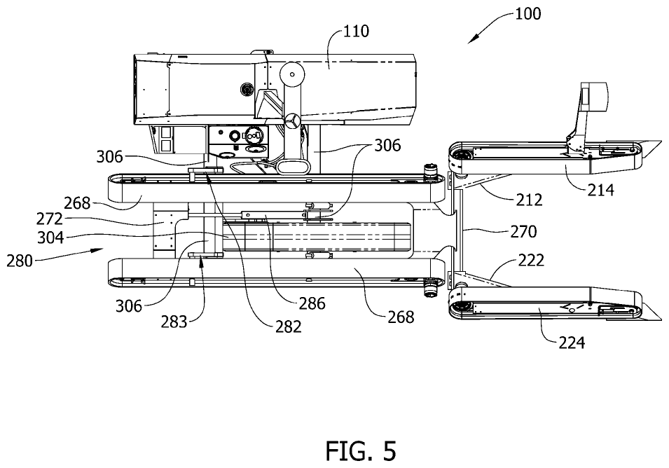

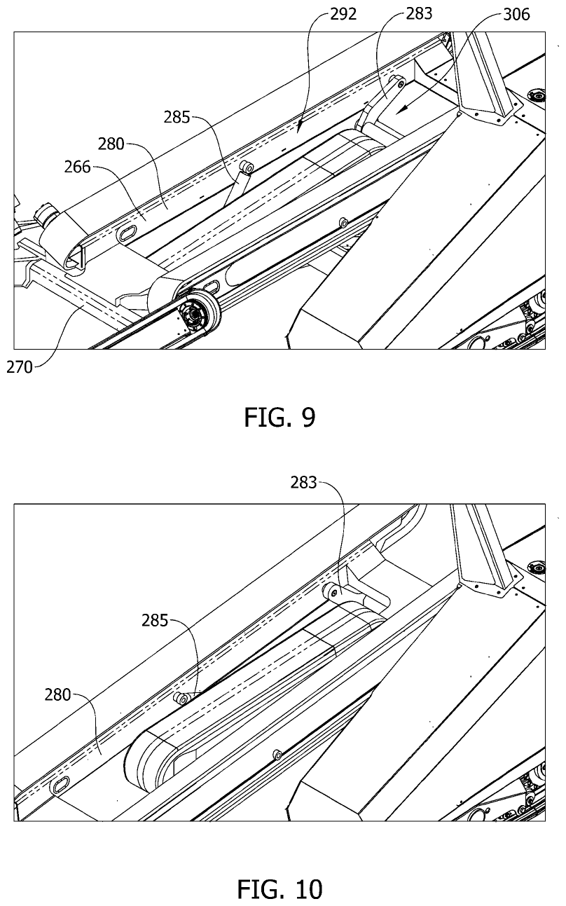

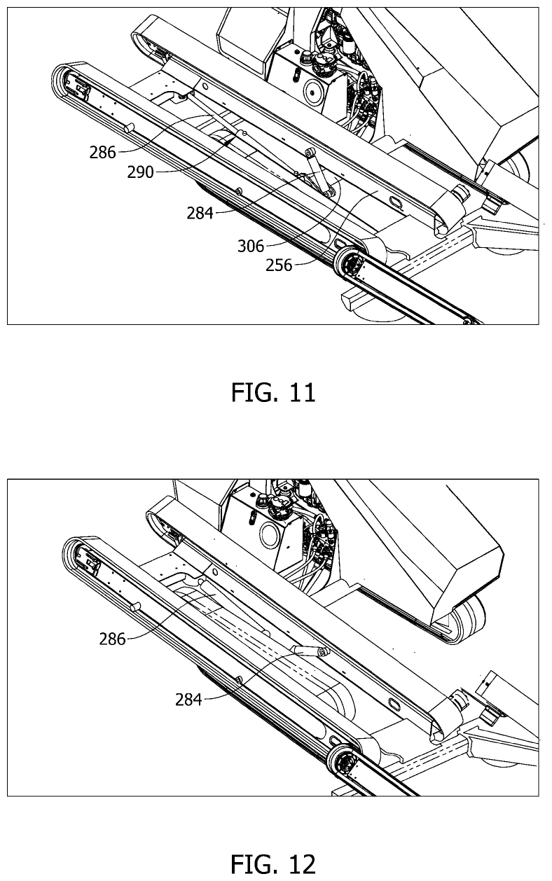

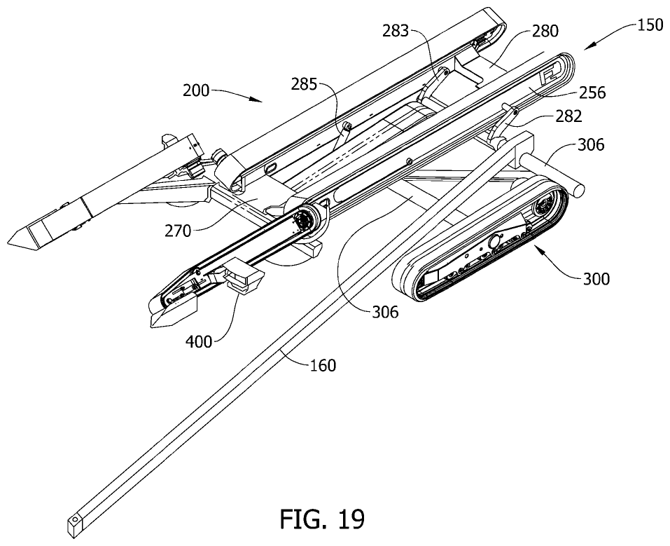

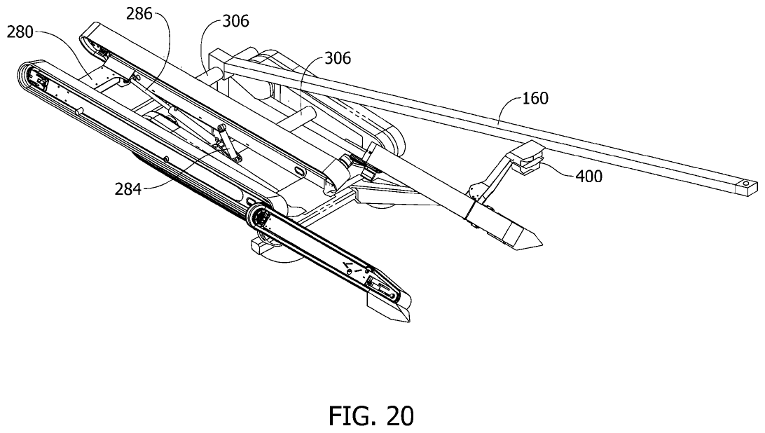

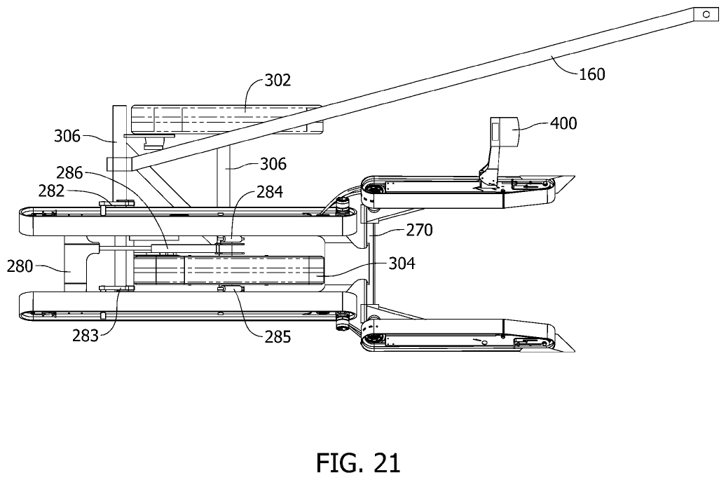

Referring now to FIGS. 9-12, the bed frame 280 is connected to and supported by the main frame 306 (FIG. 5, also shown in the embodiment illustrated in FIGS. 19-21) of the mover 150 by a pair of rear links 282, 283, and a pair of front links 284, 285. Each link 282, 283, 284, 285 is pivotally connected to the main frame 306 and to the bed frame 280. The rear link 282 (FIG. 19), front link 284, first bale conveyor frame 256, and main frame 306 form a first four-bar linkage 290 (FIG. 11) for moving the bed frame 280. The rear link 283, front link 285, second bale conveyor frame 266, and main frame 306 form a second four-bar linkage 292 (FIG. 9) opposite the first four bar-bar linkage 290 for moving the bed frame 280.

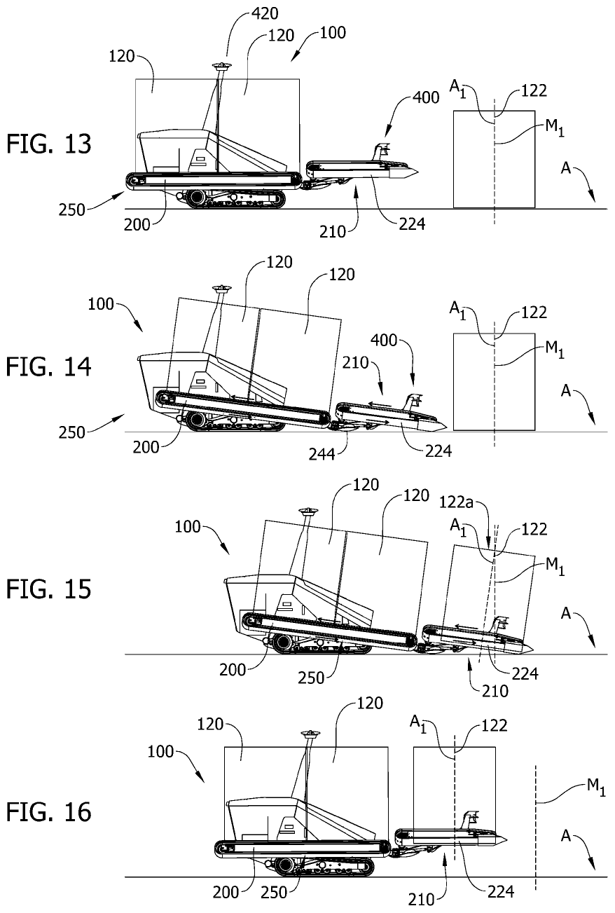

The bed frame 280 is moveable relative to the main frame 306 between a transport position (FIGS. 13, 16, 22) and a bale load position (FIGS. 14, 15, 24). As the bed frame 280 moves between the transport position (FIGS. 13, 16, 22) and bale load position (FIGS. 14, 15, 24) (and vice versa), the bed frame 280 passes through an intermediate position (FIG. 23). The distance between the pivot points of each rear link 282, 283 (i.e., the pivot point formed in bed frame 280 and the pivot point formed in the main frame 306) is less than the distance between the pivot points of each front link 284, 285 (e.g., the rear links 282, 283 are shorter than the front links 284, 285), which causes one end of the bed frame 280 to be lower in the bale load position (FIGS. 14, 15, 24) relative to the transport position (FIGS. 13, 16, 22). For example, in the transport position, the bale carrying system 250 is generally horizontal (e.g., substantially parallel to the first and second ground tracks 302, 304), and in the bale load position, the bale carrying system 250 is generally angled relative to the first and second ground tracks 302, 304.

The bale loading system 210 (FIG. 1), which is mounted to the front cross-structure 270 of the bed frame 280, is in its lowest position when the bed frame 280 is in the bale load position (FIG. 24). In the intermediate position (FIG. 23), the bed frame 280 is raised to its highest position relative to the main frame 306, which increases the clearance between bales being carried by the bale loading system 210 or the bale carrying system 250 and the second track 304 (FIG. 3) of the machine chassis 300. For example, in the intermediate position, the front link 284, 285 and/or the rear link 282, 283 may have pivot points that are vertically aligned.

The bed frame 280 is moved between raised and lowered positions by an actuator 286 (FIG. 11) which, in the illustrated embodiment, is a cylinder (e.g., hydraulic cylinder). The actuator 286 is pivotally connected to the main frame 305 and is pivotally connected to the bed frame 280. The actuator 286 is shown as extended in FIG. 11 (with the bed frame 280 in the transport position) and is shown as retracted in FIGS. 8 and 12 (with the bed frame 280 in the bale load position).

Referring now to FIG. 5, the first and second bale loading conveyors 214, 224 are mounted to the front cross-structure 270 of the bed frame 280. The first bale load conveyor 214 is supported by the first bale loading arm 212 and the second bale load conveyor 224 supported by the second bale loading arm 222. A skid 244 (FIG. 8) such as a rotatable skid is connected to and disposed below each loader arm 212, 222. The skid 244 may be positioned to contact a surface below each loader arm 212, 222. For example, the skid 244 may be positioned to contact a ground surface below each loader arm 212, 222. The skid 244 may be configured to provide ground contact to limit movement of each loader arm 212, 222. In some instances, to limit movement and protect each loader arm 212, 222 from, for example, damage caused by overextending each loader arm 212, 222 when the bed frame 280 is in the bale load position.

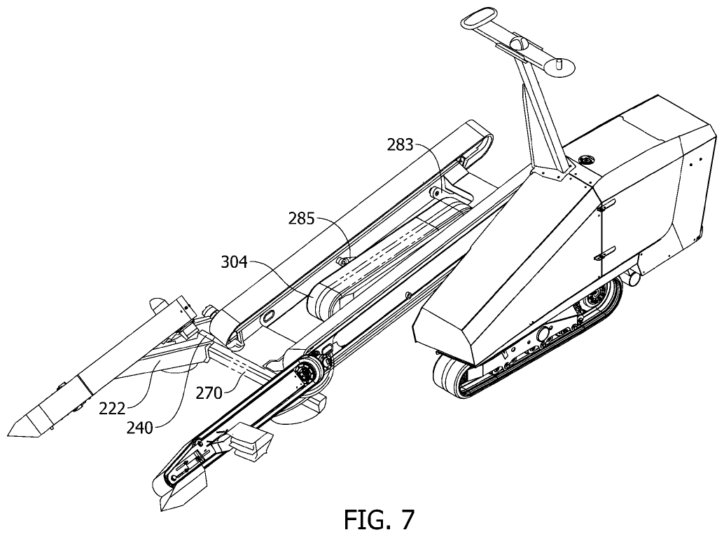

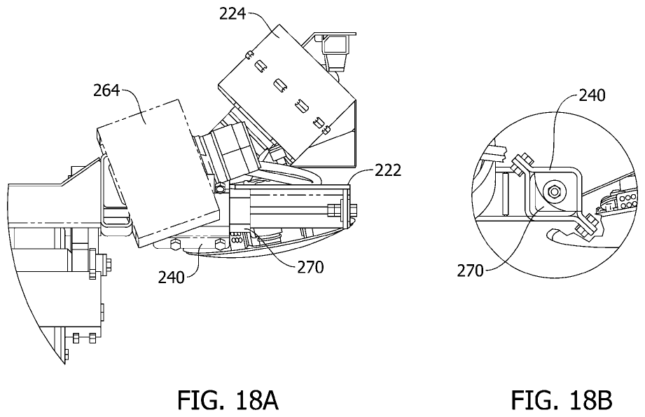

A first clamp 230 (FIG. 8) connects the first bale loading arm 212 to the front cross-structure 270. A second clamp 240 (FIG. 7) connects the second bale loading arm 222 to the front cross-structure 270. Referring now to FIGS. 18a and 18b, the front cross-structure 270 may be a square tube and the clamps 230, 240 (clamp 240 being shown) each include plates that match the profile of the cross-structure 270 and clamp down the front cross-structure 270 to hold the arms 212, 222 in fixed positions.

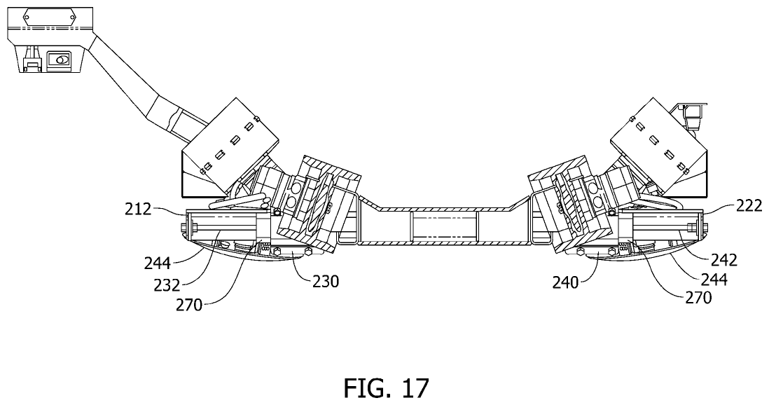

In the illustrated embodiment, the bale loading arms 212, 222 are adjustable such that the first and second bale loading conveyors 214, 224 are moveable relative to each other. In particular, the distance between the bale loading conveyors 214, 224 may be adjusted (e.g., to allow bales of different diameters to be more reliably loaded). The clamps 230, 240 may be loosened to enable the loading arms 212, 222 to move along the cross-structure 270. When the clamps 230, 240 are loosened, adjustment screws 232, 242 (FIG. 17) may be rotated to cause the bale loading arms 212, 222 to move (with rotation in one direction causing the arms 212, 222 to move toward each other and rotation in the other direction causing the arms 212, 22 to move away from each other). In other embodiments, hydraulic cylinders could be extended and/or retracted to move the bale loading arms 212, 222. In some embodiments, the control system 500 (FIG. 38) could control the spacing between bale loading arms 212, 222 based on a measurement of the bale diameter (e.g., as measured by sensors for detecting the location and orientation of the bales). In some field applications, bales within a specific field may be a consistent size in which case the operator may adjust the spacing between the bale loading conveyors 214, 224 for loading the bales within the field. In other embodiments, the control system may control the spacing between the bale loading conveyors 214, 224 to set the spacing to match individual bales as the mover 100 approaches the bale.

Referring now to FIG. 13, two bales 120 were previously loaded onto the mover 100 and the mover 100 is preparing to load a third bale 122. The control system 500 (FIG. 38) navigates the mover 100 with the bale support bed 200 in the transport position (FIG. 13) as it approaches an unloaded bale 122. As the mover 100 approaches the bale 122, the control system automatically (by input from sensors) moves the bale support bed 200 from its transport position (FIG. 13) to the bale load position (FIG. 14) by retracting actuator 286 (FIG. 5). In the bale load position (FIG. 14), the bale loading conveyors 214, 224 and a skid 244 contacts the ground. The skids 244 stabilize the bale support bed 200 as the bale loading conveyors 214, 224 first engage the bale 122.

The mover 100 is moved from the transport position (FIG. 13) to the bale load position (FIG. 14) without the mover 100 approaching the bale 122 for purposes of illustration. In such embodiments, the bale loading conveyors 214, 224 begin to move when the bale support bed 200 is lowered to the bale load position (FIG. 14). For example, the bale loading conveyors 214, 224 move in a direction away from (e.g., backward) the bale 122, as depicted by the arrow in FIG. 14.

In other embodiments, the mover 100 moves forward as the bale support bed 200 is lowered. The control and drive systems may be configured to operate the bale load conveyors 214, 224 and bale carry conveyors 254, 264 separately. The bale loading conveyors 214, 224 will start moving as the mover 100 approaches the bale. The bale loading conveyors 214, 224 may move at the same speed as the mover 100 moves along the ground (at the position of FIG. 14). As the mover moves forward (FIG. 15), the bale loading conveyors 214, 224 move underneath the bale 122 and lift it from the ground. Since the bale loading conveyors 214, 224 are moving backward, as depicted by the arrow in FIGS. 14 and 15, relative to the mover 100, the movement of which is depicted by an arrow in FIGS. 14 and 15, at the same speed that the mover 100 is moving forward relative to the ground, the bale does not move significantly in the horizontal plane while it is lifted as illustrated in FIGS. 13-15 by the generally consistent location of a reference point M1 on the bale relative to the surface A, as further described below. When referring to conveyor speed, it is intended that conveyor speed is referring to the linear speed of the bale contacting portion of the conveyor track/belt. Movement of the mover 100 in a first direction, for example in the direction toward the bale 122, and movement of the bale loading conveyors 214, 224 in a second direction, for example opposite the first direction and in the direction away from the bale 122, may reduce (or prevent) damage to the bale 122. The portion of the bale loading conveyors 214, 224 that moves in a second direction is the portion of the bale loading conveyors 214, 224 that is in direct or indirect contact with the bale 122. During loading, the speed of the mover 100 and the speed of the bale loading conveyors 214, 224 may be within about 30 percent of each other. In some instances, the speed of the mover 100 and the speed of the bale loading conveyors 214, 224 may be within about 10 percent of each other. In other instances, the speed of the mover 100 and the speed of the bale loading conveyors 214, 224 may be within about 5 percent of each other. For example, the speed of the mover 100 may be within about 15 percent of the speed of the bale loading conveyors 214, 224.

In one example, the bale 122 is positioned at a first position within a space. As shown in FIG. 13, the bale 122 is positioned in the first position on surface (A) in the orientation to be loaded by the mover 100. It should be understood that additional movement of the bale 122 may be required in order to load the bale 122 onto the mover 100. However, this example assumes that the bale 122 is positioned and ready for loading onto the mover 100. In the first position, the bale 122 is in a stationary position relative to the surface (A) of the space. The bale 122 defines a vertical axis (A₁) and the surface (A) defines a mark (M₁) that signifies the first position. The mark (M₁) is designated as a vertical line in the figures for ease of visualization.

As the mover 100 approaches the bale 122 and transitions from the transport position (FIG. 13) to the bale load position (FIG. 14), the bale 122 remains stationary in the first position. As illustrated, the vertical axis (A₁) of the bale 122 is aligned with the mark (M₁) on the surface (A). During loading of the bale 122 by the mover 100, as shown in FIG. 15, the bale 122 begins to transition from the first position (FIGS. 13-15) to a second position (FIG. 16). The bale 122 arrives at the second position when the bale 122 is supported by the mover 100 and no longer supported by the surface (A).

During loading, the bale 122 has no translational movement or minimal translational movement relative to the first position, as indicated by the location of the vertical axis (A₁) of the bale 122 relative to the mark (M₁) of the surface (A). The bale 122 may not move in the horizontal direction or may minimally move in the horizontal direction relative to the surface (A) of the space. For example, the bale 122 may move less than about 40 percent of the width of the bale 122. The bale 122 may move less than about 20 percent of the width of the bale 122. The bale 122 may move less than about 10 percent of the width of the bale 122. Although the bale 122 tilts on an angle relative to the surface (A), the vertical axis (A₁) of the bale 122 and the mark (M₁) remain intersecting (or close thereto) at a top surface 122A of the bale 122, thus indicating that the bale 122 has minimally moved from the first position. By reducing the translational movement of the bale 122 during loading, there is a decreased risk of damage to the bale 122, which may occur by dragging the bale 122 along the surface (A). For example, if the bale 122 has a wrapping, damage to the wrapping may occur by dragging the bale 122 along the surface (A) during loading onto the mover 100.

In the second position, the bale 122 is free to move translationally as required. The bale 122 in the second position may be at a position different from the first position, however, it should be understood that the bale 122 may still be at the mark (M₁) when in the second position and fully supported by the mover 100.

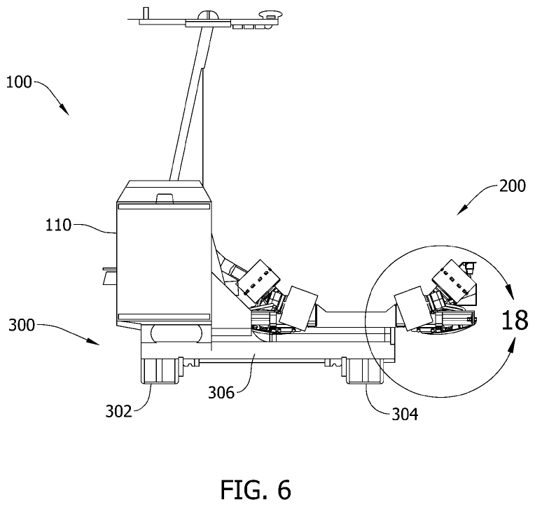

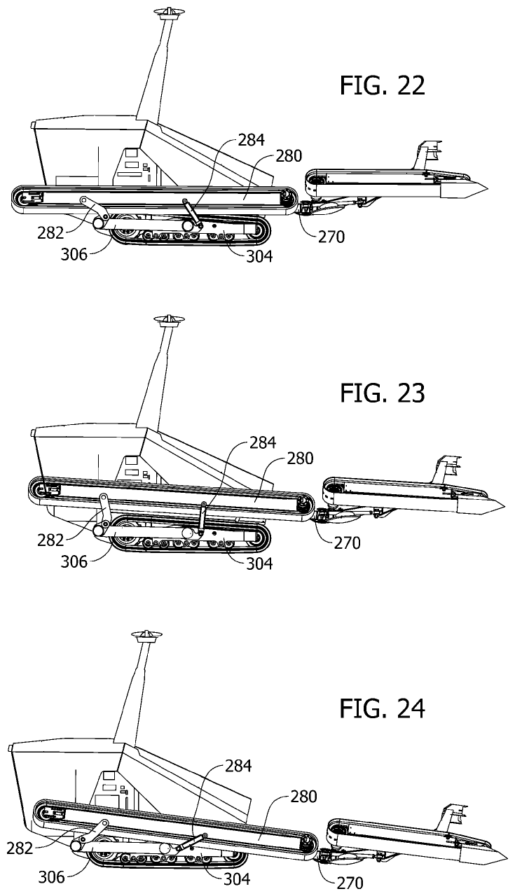

FIG. 16 shows the bale 122 being lifted to the transport position without the mover 100 moving forward from the position in FIG. 15. In other embodiments, the mover 100 moves forward without stopping as it moves to the transport position (FIG. 16). To move to the transport position, actuator 286 (FIG. 5) is extended to cause the support bed 200 to move backward while also lifting and rotating the bed as shown in FIGS. 22-24. In the transport position (FIG. 16), the bales carried by the bale support bed 200 are disposed over the second ground track 304 (FIGS. 5 and 6).

If the mover 100 was not carrying previously loaded bales 120 (or only one bale), the bale loading conveyors 214, 224 would be powered to move the bale 122 back to the bale carrying conveyors 254, 264 which would be separately controlled and powered to move the bale back along the bale carrying system 250. The bale loading conveyors 214, 224 and the bale carrying conveyors 254, 264 may operate at similar speeds. The bale carrying conveyors 254, 264 may operate at a speed that is within about 15 percent of a speed of the bale loading conveyors 214, 224. Thus, transition of the bale 122 from the bale loading conveyors 214, 224 to the bale carrying conveyors 254, 264 may occur within about a 15 percent speed variation between the bale loading conveyors 214, 224 and the bale carrying conveyors 254, 264.

In some instances, the mover 100 may define positions along the bale carrying conveyors 254, 264 that are spaced to hold at least one bale 122. When loaded, the first bale 122 may move to a first position along the bale carrying conveyors 254, 264. The first position may be closest to the bale loading conveyors 214, 224. When a second bale 122 is loaded, the first bale 122 may move to a second position along the bale carrying conveyors 254, 264 and the second bale 122 may move to the first position. The number of positions along the bale carrying conveyors 254, 264 may be equal to or one less than the total number of bales 122 that the mover 100 can hold. For example, if the mover 100 has a maximum loading capacity of three bales 122, then the bale carrying conveyors 254, 264 may be configured to carry two or three bales 122 and thus defines two or three bale positions.

In some embodiments, for example using a three-bale mover, when two bales are previously loaded as shown in FIGS. 13-16, the bale loading conveyors 214, 224 are operated to move bale 122 and the bale carrying conveyors 254, 264 are not operated. The bale 122 may be moved back along the bale loading conveyors 214, 224 until the bale is adjacent or contacts the previously loaded bales 120 carried on the bale carrying system 250.

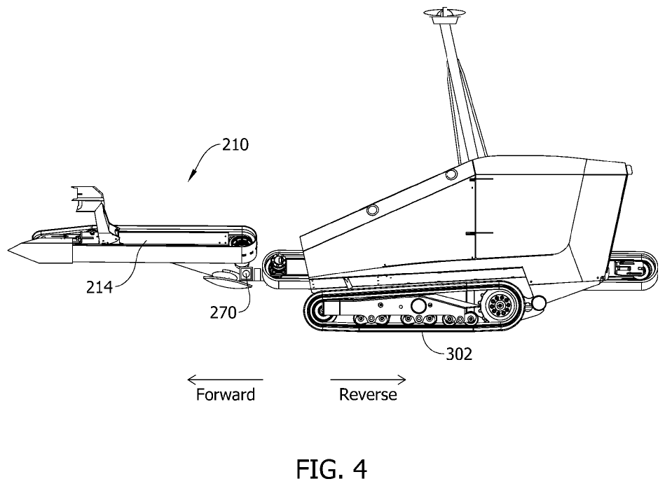

In the illustrated embodiment, once three bales are loaded, the mover 100 moves to a desired storage or staging site. In other embodiments, fewer or more bales are carried by the mover 100 and loaded before moving to the staging site. Once at the staging site, the loading process is reversed and the bale support bed 200 is moved from the transport position (FIG. 16) to the lowered bale load position (FIG. 15). In the bale load position (FIG. 15), the first and second ground tracks 302, 304, the bale loading conveyors 214, 224, and the bale carrying conveyors 254, 264 may be reversed to move the bales off the mover 100 and unload them onto the ground off the front 318 (FIG. 1) of the mover 100. The mover 100 may travel in reverse as the bales are unloaded. The travel of the mover 100 is indicated by the arrows in FIGS. 3 and 4. The reversal of the bale loading conveyors 214, 224 and the bale carrying conveyors 254, 264 is opposite from the movement of the mover 100. Thus, in reverse, the bale loading conveyors 214, 224 and the bale carrying conveyors 254, 264 move in the direction identified by the forward arrow. The portion of the bale loading conveyors 214, 224 and the bale carrying conveyors 254, 264 that move in the forward direction is the portion of the bale loading conveyors 214, 224 and the bale carrying conveyors 254, 264 that is in direct or indirect contact with the bale 122. The reverse speed of the bale loading conveyors 214, 224 and bale carrying conveyors 254, 264 may be controlled to be proportional to the ground speed of the mover 100. In some embodiments, the reverse speeds of the bale loading conveyors 214, 224 and bale carrying conveyors 254, 264 are 5-20% faster than the mover's ground speed. The speed difference causes the bales to be maintained close together as they are set in row. During unloading, the speed of the mover 100, the speed of the bale loading conveyors 214, 224, and the bale carrying conveyors 254, 264 may be within about 40 percent of each other. In some instances, the speed of the mover 100, the speed of the bale loading conveyors 214, 224, and the bale carrying conveyors 254, 264 may be within about 20 percent of each other. In other instances, the speed of the mover 100, the speed of the bale loading conveyors 214, 224, and the bale carrying conveyors 254, 264 may be within about 15 percent of each other, and in some cases, within about 5 percent of each other. For example, the speed of the mover 100 and the speed of the bale carrying conveyors 254, 264 may be within about 40 percent of the speed of the bale loading conveyors 214, 224. In some instances, the speed of the mover 100 and the speed of bale carrying conveyors 254, 264 may be within about 10 percent of each other. In other instances, the speed of the mover 100 and the speed of the bale carrying conveyors 254, 264 may be within about 5 percent of each other. For example, the speed of the mover 100 may be within about 15 percent of the speed of the bale carrying conveyors 254, 264.

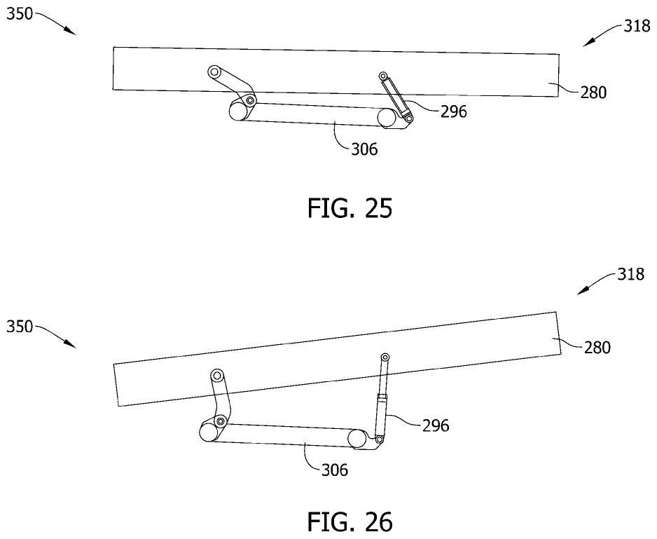

In some embodiments for unloading bales, the bales may be unloaded to the rear 350 (FIG. 1) of the mover 100. In some embodiments in which the mover 100 is configured for unloading to the rear 350, actuators 296 (FIGS. 25-26) are used instead of front links. The actuators 296 (e. g., cylinders such as hydraulic cylinders) may be retracted (FIG. 25) or extended (FIG. 26) to tilt the bed frame 280. When extended (FIG. 26), the rear of the bed support bed 200 is lowered to enable bales to be moved off the rear 350 of the mover 100.

The bale mover 100 may include a sensor hub 400 (FIG. 1) that includes a package of one or more sensors that provide data to a control system 500 (FIG. 38) to identify the location and orientation of round bales that are intended to be loaded and transported to a storage or staging location. The sensor hub 400 (which may also be referred to herein as “environmental perception sensor package 400” or more simply “sensor package 400”) may be mounted to the first bale loading conveyor frame 216. The sensor hub 400 may include various sensors including lidar, camera, laser, radar and any combination thereof. The sensor hub 400 may produce a fusion of data from a plurality of sensors. The data collected by the sensor package 400 may measure a dimension (e.g., width, diameter) of the bale before the mover approaches the bale or as the mover approaches the bale. A geo-spatial sensor 420 (FIG. 1) may also transmit data to the control system to track the position and orientation of the bales to navigate the self-propelled mover 100 as further described below in “Navigation Systems”.

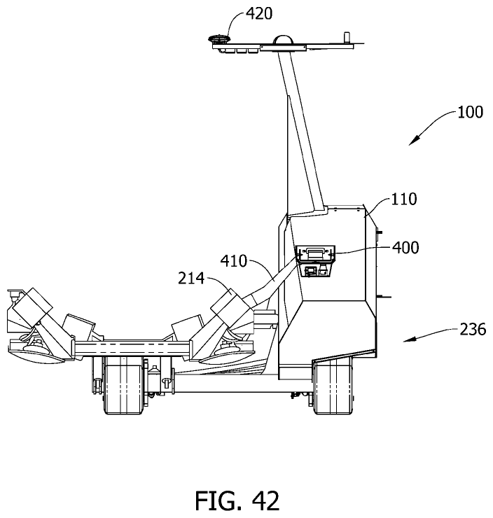

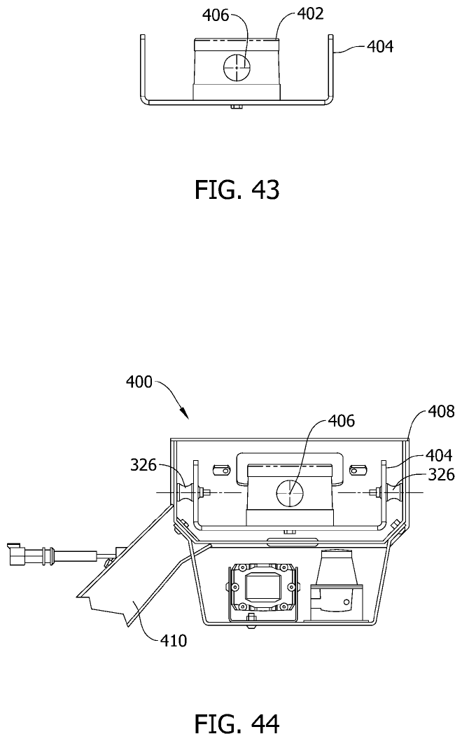

Referring now to FIG. 42, the sensor hub 400 is mounted to the first bale loading conveyor frame 216 on the first side 236 of the mover 100. The geo-spatial sensor 420 is mounted to and disposed above the power unit 110 and is also mounted toward the first side 236 of the mover 100. The sensor hub 400 includes a first sensor 402 (FIG. 43) and may be a lidar sensor. The lidar sensor 402 is connected to a mounting bracket 404. The sensor 402 and bracket 404 form an assembly having a center of gravity 406. The location of the center of gravity 406 may reduce sensor 402 movement as the mover 100 travels around the space.

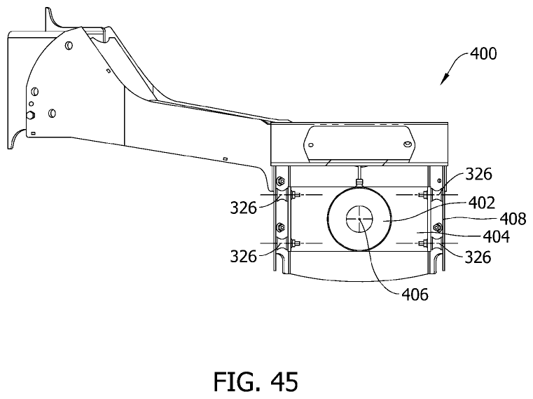

The sensor hub 400 has a hub housing 408 (FIG. 44) with the lidar sensor 402 and mounting bracket 404 disposed within the housing 408. The sensor hub 400 includes isolators 326 disposed between the hub housing 408 and the mounting bracket 404. AS shown in FIG. 44, the centerlines of each isolator 326 intersects the center of gravity 406 of the sensor/bracket assembly when viewed from the front. The isolators 326 may be mounted in a horizontal orientation with a shear configuration in which the isolator 326 presents its lowest stiffness characteristics. The hub 400 includes four isolators 326 (FIG. 45) that support the mounting bracket 404 (with the centerline of the isolators 326 being offset from the center of gravity 406 when viewed from above).

The bracket 404 and sensor 402 may be suspended with a relatively low stiffness in the vertical plane, while being held more rigid in the horizontal plane. The isolators 326 allow the sensor 402 to identify bales and bale orientation while being protected against the vibrations associated with the travel of the mover 100.

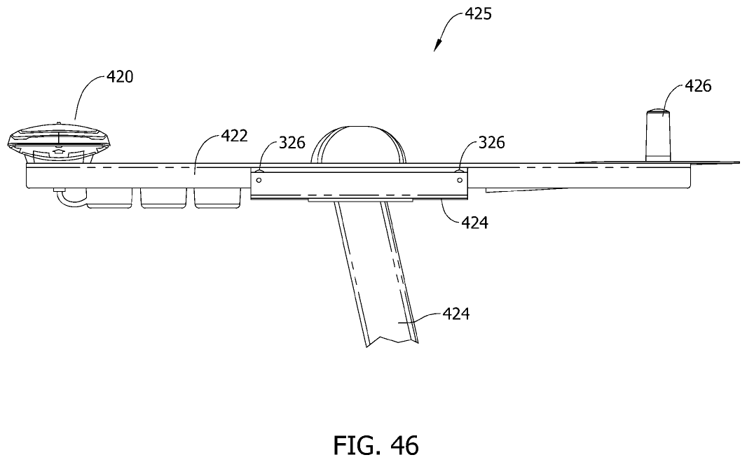

Referring now to FIG. 46, the geo-spatial sensor 420 is part of a geo-spatial sensor hub 425 (which may include additional sensors). The geo-spatial sensor 420 is mounted to a support bar 422 in the hub 425. An indicator 426 (e.g., for alerting people in the vicinity of the machine of the machine's operating status) may be mounted to the support bar 422 opposite the geo-spatial sensor 420. The support bar 422 is mounted to a mast 424. The hub 425 includes isolators 326 (e.g., four isolators 326).

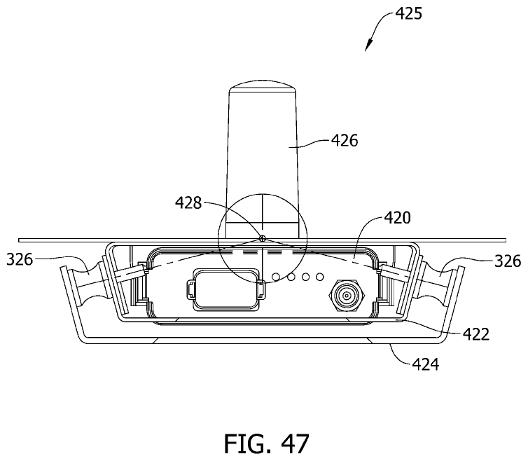

The support bar 422, indicator 426 and geo-spatial sensors 420 together form an assembly having a center of gravity 428 (FIG. 47). Each isolator 326 includes a centerline (FIG. 47) with the centerline of each isolator 326 intersecting the center of gravity 428 (e.g., in a focal arrangement). The stiffness of the isolators 326 in the vertical direction is higher than if the isolators 326 were oriented horizontally in a shear orientation. The sensor 420 may provide relatively accurate location data for the control system 500 (FIG. 38) while being protected from vibrations.

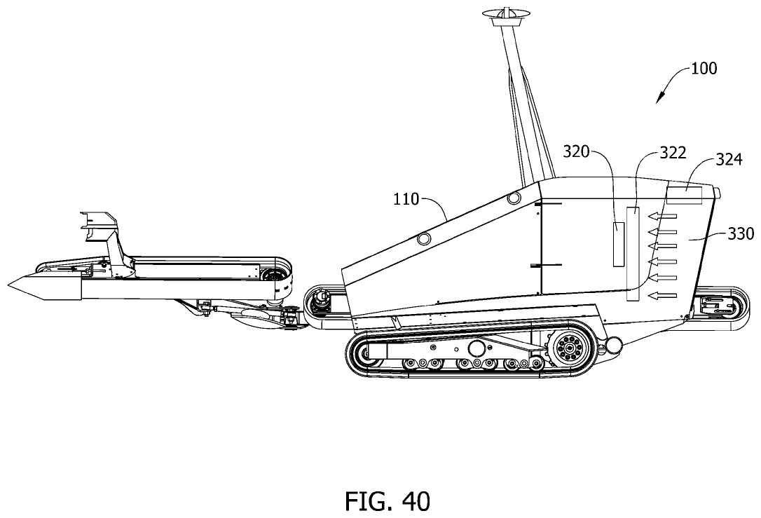

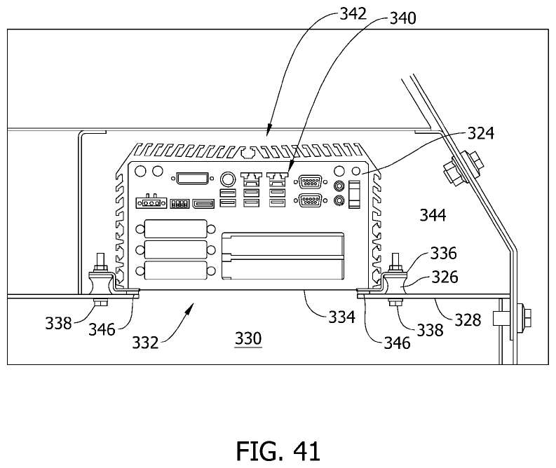

Referring now to FIG. 40, the power unit 110 of the self-propelled bale mover 100 includes a cooling fan 320. The cooling fan 320 is configured to pull air through a radiator 322 and a duct 330 for cooling an internal combustion engine and the hydraulic systems of the bale mover 100. A controller 324 that navigates the mover is mounted in a location where the air flow for cooling the engine passes by a convective cooling surface of the controller 324. Referring now to FIG. 41, in some embodiments, an engine enclosure 328 is configured with a controller aperture 332 that exposes the convective cooling surface 334 of the controller 324 to airflow in the duct 330.

The controller 324 is mounted to a controller mount plate 336 (e.g., with screws or fasteners). The mount plate 336 is mounted to the enclosure 328 and sets on isolators 326 held in place with fasteners 338. The isolators 326 allow relative motion between the controller 324 and the enclosure 328, to isolate the controller from the vibrations of the bale mover 100 (e.g., tracking and engine vibration).

Example isolators 326 (for the controller and sensors 402, 420) include DIABOLO MOUNTS, type F.00N (Aplicaciones Mecánicas del Caucho (AMC MECANOCAUCHO)). The example isolators 326 may have a maximum rated compression (vertical) load of 27 pounds at 0.10 inches of deflection and, in a shear configuration, a maximum vertical load of 6.75 pounds at 0.2 inches of deflection. In a focalized configuration, the maximum rated vertical load and deflection may be determined through the combination of the compression and shear stiffnesses.

The controller 324, lidar sensor 402 and geo-spatial sensor 420 may be mounted in one of these configurations (compression (base), shear and focalized). Although the components'static weights differ, a vertical natural frequency below 20 Hz can be achieved in each case, which allows a theoretical mount transmissibility below 0.10 for engine vibration and below 0.50 for tracking vibration. The maximum vertical load, natural frequency, transmissibility specified herein are example ranges and other ranges may be used unless stated differently.

The controller 324 includes a plurality of connectors 340 and the enclosure 328 includes a plurality of bulk head connectors 342 on a side wall. This provides a sealed chamber 344 in which the controller 324 is disposed while exposing the convective cooling surface 334 to the flow of air within the duct 330.

Seals 346 (e.g., compressible materials such as weather stripping) may be positioned around the controller aperture 332 in the enclosure 328. For example, the seals 346 may be disposed between the enclosure 328 and the controller mount plate 336 to seal the chamber 344 while also allowing the relative movement to allow the isolators 326 to function.

Another embodiment of the bale mover is referred to generally as “150” in FIGS. 19-21. The illustrated bale mover 150 is a towed implement (e.g., towed by a tractor). The bed frame 280 of the towed bale mover 150 and its connection to the main frame 306 may be similar or identical to the bed frame 280 of the self-propelled bale mover 100 described above. The bale mover 150 does not include a dedicated power unit. The mover 150 includes a tongue 160 for connecting to a towing machine (e.g., tractor). The mover 150 may include a sensor hub 400. In other embodiments, the towing machine may include sensors that detect the position and orientation of round bales (or is guided by an operator) and the mover 150 does not include a sensor hub 400.

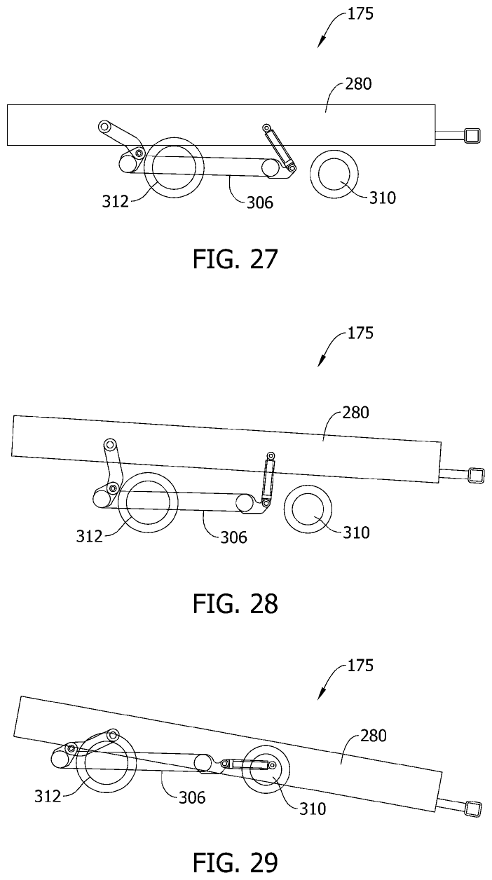

Another embodiment of the bale mover is referred to generally as “175” in FIGS. 27-29. The bale mover 174 includes front and rear wheels 310, 312 and not ground tracks. The wheels 310, 312 are connected to the main frame 306. The bed frame 280 of the wheeled bale mover 175 and its connection to the main frame 306 may be similar or identical to the bed frame 280 of the self-propelled bale mover 100 described above.

### Navigation Systems

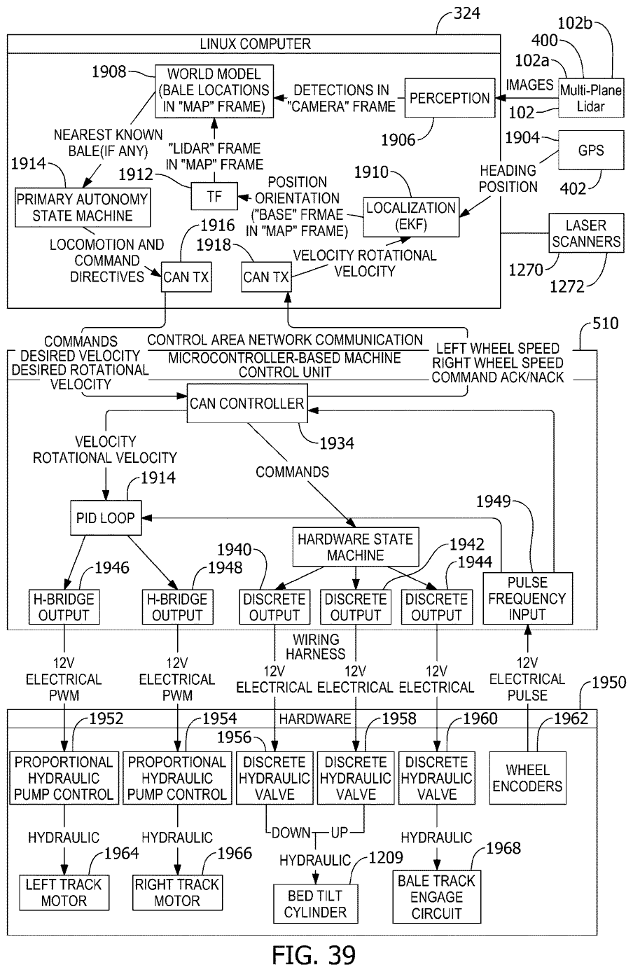

As noted above, the control system of the bale mover includes a sensor hub 400 (e.g., environmental perception sensor package 400) for detecting objects in the space around the bale mover 100 and includes a geo-spatial sensor hub 420 having a package of one or more sensors for detecting the geo-spatial position of the mover 100. These sensors may be incorporated or mounted on the mover 100 as illustrated in FIG. 1. The sensors may be integrated into a control system 500 shown in FIG. 38. The control system 500 includes a guidance controller 324 (FIG. 38) that controls navigation of the bale mover 100. The control system 500 also includes a cellular gateway 430 (FIG. 38) mounted to the bale mover 100. In the illustrated embodiment, the cellular gateway enables a communication link through a cellular signal to the cloud and to interface module 432. The interface module 432 includes an electronic adaptor 434 and bale mover algorithms 436 that enable the transfer of data to and from additional control system components such as the guidance controller 324 (FIG. 39). The components of FIG. 39 correspond to components described in U.S. Patent Publication No. 2021/0342628, which is incorporated herein by reference for all relevant and consistent purposes.

The user may locally connect to the mover 100 over Wi-Fi (with a phone or tablet) to send a field plan to the mover 100 and to begin bale loading operations. The user may monitor productivity of the mover 100 and monitor the status and active faults using a cellular connection (assuming both the mover and the phone/tablet has cellular connection). A local connection (not shown) between the cellular gateway and a mover application may be included in the system 500.

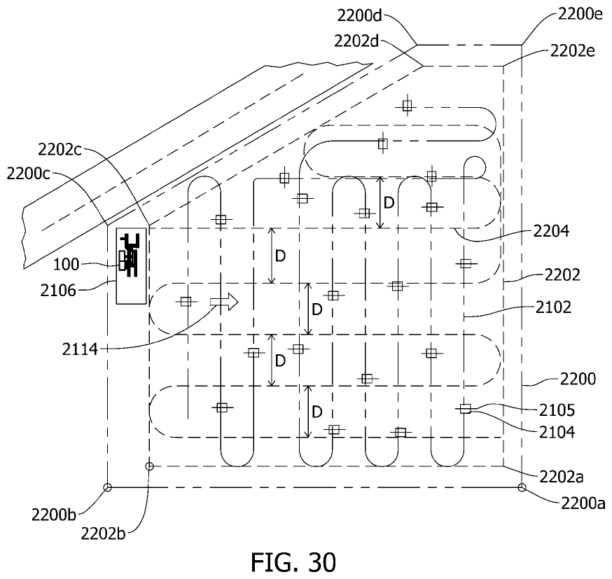

A bale mover phone application contains algorithms to allow a user to define a project. Referring now to FIG. 30, the project may be a representation of a field where a baler previously travelled along a travel path 2102 while forming and placing bales 2104. The project definition includes the definition of a geo-fence 2200. In some embodiments, the user interacts with a map on a mobile device such as a mobile phone or a tablet to drop points at corners of the geo-fence 2200. In other embodiments, the user walks around the field to define corners of the geo-fence at specific points. The geo-fence 2200 may include a plurality of corners. As illustrated in FIG. 30, reference numbers 2200A, 2200B, 2200C, 2200D, 2200E depict the corners of the geo-fence 2200.

To establish corners, points may be placed on a satellite map or the internal GPS of the phone/tablet may be used with the user walking or driving to each desired point. The user may also define a working area 2202 within the geo-fence 2200. The working area 2202 is an area within which the bale mover 100 is intended to operate and the geo-fence 2200 defines an area that the mover 100 does not exit. The working area 2202 may define corners at specific points. The working area 2202 may include a plurality of corners. As illustrated in FIG. 30, reference numbers 2202A, 2202B, 2202C, 2202D, 2202E depict the corners of the working area 2202.

Once the working area 2202 is defined, the control system 500 defines a scour pattern 2204 which is an intended travel path for the bale mover 100. The scour pattern 2204 will be a series of generally parallel paths within the working area 2202, spaced apart by a distance (D) that will allow the sensor(s) of the sensor hub 400 to reliably detect bales (e.g., provide a field of view for the sensor(s)). This field of view may be determined by the capability of the sensors, or a combination of the capability of the sensors and other factors such as environmental conditions (e.g., the number of bales expected or measured within the working area).

The orientation or direction of the scour pattern 2204 may be determined by an operator's selection of bale angle 2114. The bale angle 2114 is the direction that the majority of the bales in that working area 2202 will be approached for loading. Round bales will be approached from a direction parallel to the bale axis. If the bales 2104 are round bales with an axis 2105, the bale angle will be zero degrees. This selection will result in a scour pattern 2204 with rows running horizontally as shown in FIG. 30. For round bales, a scour pattern perpendicular to the direction of the travel path 2102 is generally more efficient because the orientation of the bale tends to align more closely to the required orientation of the bale relative to the mover for bale pick-up by the mover.

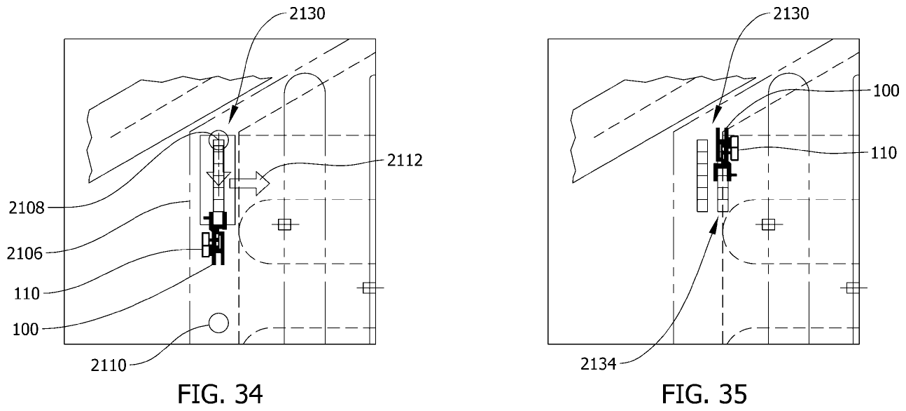

The user may also define a stacking location 2106 which is the location where the bales are to be moved. As illustrated in FIG. 34, the stacking location includes (for a first row of bales) a starting point 2108 which is where the first bale will be located and an end point 2110 of the row. The user may also define the distance between stacks, variations of which are depicted in FIGS. 34-37. In some instances, the user may define the distance between stacks and the mover 100 will determine how best to achieve the spacing, for example, by altering the direction the mover 100 approaches and unloads the bales into the stacks.

A stack direction 2112 may also be selected. The stack direction 2112 is the direction in which subsequent rows will be placed. The stack direction 2112 affects subsequent path planning for the bale mover 100 as it approaches the stacking location 2106 with a load of bales. For example, the stack direction 2112 may impact the direction that the bale mover 100 approaches the stack location 2106 and may affect the method of unloading the bales (e.g., forward or reverse unloading).

As shown in FIG. 34, the power unit 110 is positioned on the left side of the mover 100 as the first row 2130 is unloaded. The bale mover 100 unloads the bales in the first row 2130 by lowering the bale bed and backing up. After the first row 2130 is formed and as shown in FIG. 35, the bale mover 100 approaches in the opposite direction from which the first row 2130 was unloaded, with the power unit 110 on the right side. The bale mover 100 places the first bale of the second row 2134 adjacent to the end point of the first row 2130, and then backs up to unload the bales.

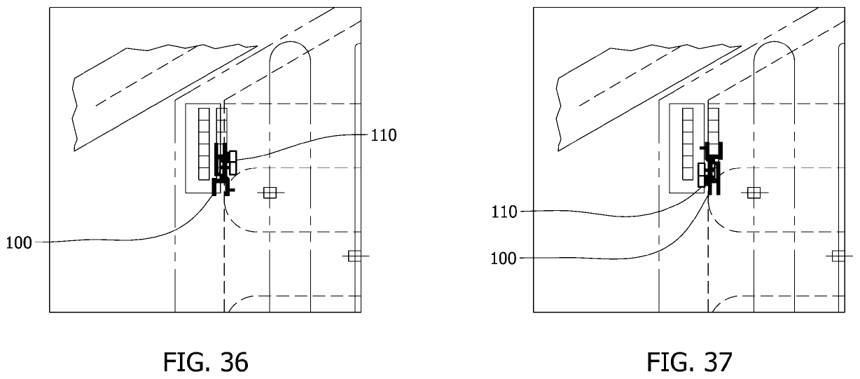

As shown in FIG. 36, the bale mover 100 has approached the stack location 2106 with the power unit 110 on the right side with the bales being unloaded off the rear of the bale bed and the mover 100 moving forward.

As shown in FIG. 37, the bale mover 100 has approached the stack location 2106 with the power unit 110 on the left side. The bale mover 100 may drive forward to locate the first bale in the first row 2130 that is adjacent to the starting point 2108 (FIG. 34) and backs up to unload the bales from the front of the mover 100 (with the rows being separated by at least the width of the power unit 110).

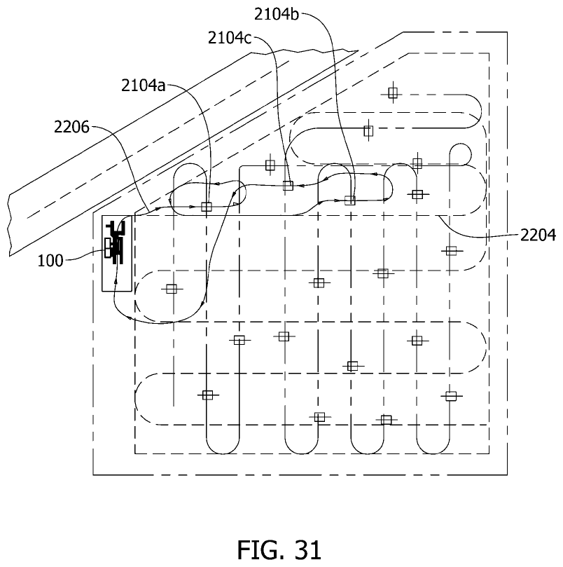

Once the control system 500 produces a scour pattern (e.g., the example scour pattern 2204 shown in FIG. 30), the bale mover 100 is propelled to follow the scour pattern (e.g., from the initial starting point which is near the stacking location 2106 in FIG. 30). As shown in FIG. 31, as the bale mover 100 moves along a first path 2206, the sensor(s) of the sensor hub 400 detect a first bale 2104A. The control algorithm causes the mover 100 to deviate from the scour pattern and to align with the axis of the first bale 2104A. Once the first bale 2104A is loaded, the control algorithms cause the mover 100 to return to the scour pattern 2204 (e.g., at a location near where the bale mover 100 deviated from the scour pattern). The bale mover 100 follows the scour pattern 2204 and repeats the process for loading a second bale 2104B. In this example, after the second bale 2104B is loaded, a third bale 2104C is detected (which, in the illustrated embodiment, was detected before the mover 100 returned to the scour pattern 2204) and the control algorithms cause the mover 100 to align with the axis of the third bale 2104C and to load the third bale 2104C. Once the third bale 2104C is loaded, the bale mover 100 moves to the stacking location 2106 to unload that first load of bales.

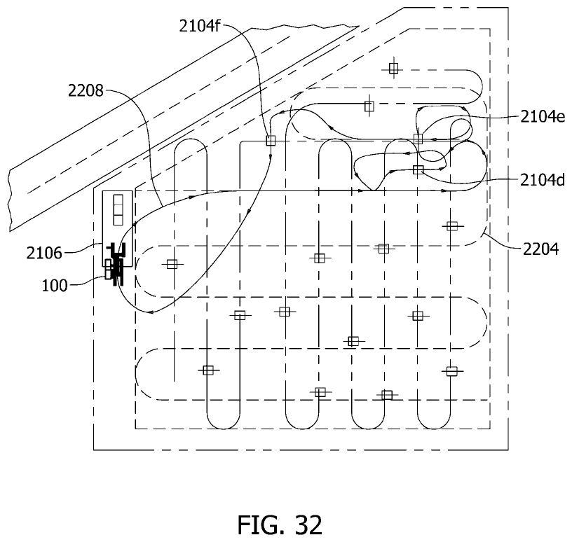

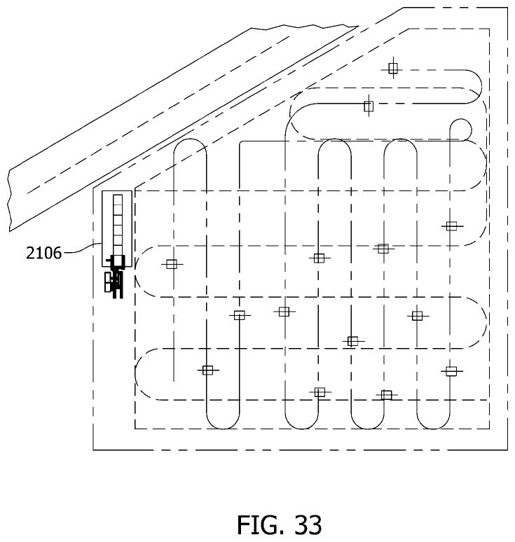

Referring now to FIG. 32, the bale mover 100 starts from where it has unloaded the first load of bales and moves to follow the scour pattern 2204 along a second path 2208 until the sensor(s) detects the fourth bale 2104D. The bale 2104D is loaded and the bale mover returns to the scour pattern until it detects fifth bale 2104E. Because the fifth bale 2104E is angled differently from the other bales, the sensors 400 and the related control algorithms cause the bale mover 100 to approach the bale 2104E differently. After the fifth bale 2104E is loaded, the bale mover 100 returns to the scour pattern 2204 until the bale mover 100 detects a sixth bale 2104F. After loading the sixth bale 2104F, the bale mover 100 returns to the stacking location 2106 where the bale mover 400 positions the second load of bales in line with the first load.

The illustrated path planning technique involves production of a scour pattern by gathering data and defining a geo-fence, a working area within the geo-fence, a stacking location along with a stack direction, a field of view for the environmental perception sensor package 400, and a bale angle (e.g., without using more detailed data such as data related to the location of the bales). This approach involves configuring the bale mover to identify bales and to identify bale orientation without predetermined definition of the location of the bales.

The control system 500 is capable of monitoring data related to the status of machine operation and relaying that data back to the cloud, and to an operator either at a smart phone or a desk-top system as shown in FIG. 38. The data may relate to, for example, the percentage of the working area that the machine has covered or the number of bales moved within the working area. The data may also include operational information such as a warning that the machine has stopped (e.g., due to detection of an obstacle).

The illustrated bale mover 100 includes sensors that are able to monitor the space around the mover 100 to detect objects in its path of travel. These sensors allow the mover 100 to avoid coming in contact with obstacles and define a first and second zone around the mover. The first zone is larger, and if any obstacles are identified within the first zone as the mover 100 travels, the mover 100 will slow down and attempt to avoid the detected object, while continuing to move in a different direction. The second zone is smaller, and if any obstacles enter the second zone as the mover 100 travels, the bale mover 100 stops. The size of these zones may be based on the speed that the bale mover 100 is travelling. Changing the size of the zones based on the speed of the mover 100 enables the mover 100 to move slower in areas where it first detects obstacles and to find an acceptable path between bales for proper bale loading.

Compared to conventional bale movers, the bale movers of the present disclosure have several advantages. Links that pivotally connect with the main frame and the bed frame enable the bed frame to be moved between transport and bale load positions. By lowering the bed frame during bale loading, bales may more easily and more reliably be moved onto the bale mover. In embodiments in which the bale mover includes loader arms that are adjustable, the bale mover is adaptable to load bales of different sizes (e.g., widths, diameters). In embodiments in which the bale mover includes isolators, the isolators that support the controller, the isolators that support the sensor hub (e.g., lidar sensor), and the isolators that support the geo-spatial sensor hub may be identical such that common isolators may suspend three different electrical components, optionally with different mounting arrangements. Controller mounting may orient the isolator in a base mount configuration. Lidar sensor mounting orients the isolator in a shear arrangement. Geospatial sensor mounting orients the isolator in a focal arrangement. A common isolator is able to provide the required isolation or suspension characteristics required for each controller or sensor.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a,” “an,” “the,” and “said” are intended to mean that there are one or more of the elements. The terms “comprising,” “including,” “containing,” and “having” are intended to be inclusive and mean that there may be additional elements other than the listed elements. The use of terms indicating a particular orientation (e.g., “top,” “bottom,”“side,” etc.) is for convenience of description and does not require any particular orientation of the item described.

As used herein, the term “autonomous” refers to the operation of a bale mover based on at least one of the following levels, in no particular order. Level 1, the bale mover includes partial autonomation and partial manual operation of required tasks and in instances of partial automation, an operator still monitors operation and may take control at any time. Level 2, the bale mover can detect its environment and can perform most operational tasks, but operator intervention is still required in some instances. Level 3, the bale mover has a high level of autonomation for all tasks under certain situations, typically within a geofenced area (e.g., a space), and operator intervention is an option but not required within the defined space. Level 4, operation of the bale mover is fully automated with no human intervention required. Said differently, the bale mover performs all machine safety-critical and operational-critical functions related to its defined operations without operator interaction.

As used herein, an “obstacle” may include, but is not limited to, an unmovable item (e.g., tree, rock, fence), a semi-permanent item (e.g., an abandoned piece of equipment), an unpicked bale material, a group of picked bale materials, and combinations thereof.

As used herein, the “space” refers to an area where a bale mover may operate. In non-limiting examples, the space refers to a field, a building, a road, and combinations thereof.

As used herein, “scour”, “scouring”, and the like refer to an action a bale mover conducts as it navigates along a preplanned path searching for bale materials within a space.

As various changes could be made in the above constructions and methods without departing from the scope of the disclosure, it is intended that all matter contained in the above description and shown in the accompanying drawing[s] shall be interpreted as illustrative and not in a limiting sense.

What is claimed is:

1. A method of controlling the movement of a bale mover comprising:
defining a working area;
establishing a field of view for a sensor;
selecting a bale angle; and
creating a scour pattern that covers the working area based on the field of view and the selected bale angle.

2. The method as set forth in claim 1 further comprising:
moving the bale mover along the scour pattern; and
loading bales onto the bale mover as the bale mover moves along the scour pattern.
